(19) United States
(12) Patent Application Publication
(10) Pub. No.: US 2009/0280391 A1
(43) Pub. Date: Nov. 12, 2009

(54) PACKAGE STRUCTURE FOR FUEL CELL

(75) Inventors: Hwa-Feng Chang, Hsinchu (TW); Hsiang Po Tsai, Hsinchu (TW); Chung Ping Wang, Hsinchu (TW)

Correspondence Address: APEX JURIS, PLLC, 12733 LAKE CITY WAY NORTHEAST, SEATTLE, WA, 98125, US

(73) Assignee: OPTODISC TECHNOLOGY CORPORATION, Hsinchu (TW)

(21) Appl. No.: 12/268,971

(22) Filed: Nov. 11, 2008

(30) Foreign Application Priority Data
May 7, 2008 (TW) 097116917

(51) Int. Cl. H01M 2/02; H01M 2/08

(52) U.S. Cl. 429/36; 429/34

(57) ABSTRACT

Provided is a package structure for a fuel cell, including a first polar plate and a second polar plate. The first polar plate includes a first recess used to accommodate an anode of a membrane electrode assembly (MEA), and at least a first sealed flange surrounding the first recess. The second polar plate includes a second recess corresponding in position to the first recess and used to accommodate a cathode of the MEA, and at least a first sealed groove surrounding the second recess and corresponding in position to the first sealed flange. The first sealed flange and the first sealed groove are employed to hold by clamping the periphery of the proton exchange membrane of the MEA, so as to accomplish sealing.

### CROSS-REFERENCES TO RELATED APPLICATIONS

This non-provisional application claims priority under 35 U.S.C. § 119(a) on Patent Application No(s). 97116917 filed in Taiwan, R.O.C. on 2008 May 7, the entire contents of which are hereby incorporated by reference.

### BACKGROUND OF THE INVENTION

1. Field of the Invention

The present invention relates to package structures, and more particularly to a package structure for a fuel cell.

2. Description of the Related Art

With crude oil price escalating and industries booming worldwide, petroleum resources on the earth are becoming more scarce. As a result, a variety of alternative energy options have emerged, paving the way for the development of energy technology that is environment-friendly, renewable, and energy-conversion efficient. Hence, energy-conversion efficient fuel cells are all the rage among energy technology developers.

Fuel cells are differentiated by process; electrolyte into proton exchange membrane fuel cells (PEMFC), alkaline fuel cells (AFC), phosphoric acid fuel cells (PAFC), molten carbonate fuel cells (MCFC), and solid oxide fuel cells (SOFC). Among the aforesaid types of fuel cells, proton exchange membrane fuel cells (PEMFC) are most favored for a quick start, low operating temperature, high power density, and unlikelihood of electrolyte corrosion and leakage.

A proton exchange membrane fuel cell stack includes polar plates and a membrane electrode assembly (MEA). A common stacking sequence of a fuel cell stack is: polar plate/MEA/polar plate. Alternatively, a complicated stacking sequence of a fuel cell stack is: polar plate/MEA/bipolar plate/MEA/polar plate. Fuel circulates in a fuel cell stack and ends up at a MEA thereof to undergo reaction, but readily leaks out between a bipolar/polar plate and the MEA, thereby causing contamination or short circuits. To achieve sealing, the prior art teaches using a plurality of sealing washers (O-rings, seals) or a sealing encapsulant, and performing an intricate fabrication and design process. However, the prior art has its drawbacks, namely a time-consuming, laborious, high-cost fabrication process, a heavy fuel cell stack, and inefficient sealing.

Accordingly, a conventional package structure of a fuel cell has the aforesaid drawbacks, namely time-consuming, laborious, high sealing costs, and a heavy fuel cell stack.

### SUMMARY OF THE INVENTION

In view of this, the present invention proposes a package structure for a fuel cell, including a first polar plate and a second polar plate.

The first polar plate includes a first recess used to accommodate an anode of a membrane electrode assembly (MEA), and at least a first sealed flange surrounding the first recess.

The second polar plate includes a second recess corresponding in position to the first recess and used to accommodate a cathode of the MEA, and at least a first sealed groove surrounding the second recess and corresponding in position to the first sealed flange. The first sealed flange and the first sealed groove are used to hold by clamping the periphery of a proton exchange membrane of the MEA.

In addition, the present invention also proposes another package structure for a fuel cell, including a first polar plate and a second polar plate.

The first polar plate includes a first recess used to accommodate an anode of the MEA, and at least a second sealed flange surrounding the first recess and having a top surface with a second sealed groove.

The second polar plate is provided beneath the first polar plate and includes a second recess corresponding in position to the first recess and used to accommodate a cathode of the MEA, and at least a third sealed flange surrounding the second recess and having a top surface with a fourth sealed flange. The second sealed groove and the fourth sealed flange are used to hold by clamping the periphery of a proton exchange membrane of the MEA.

The aforesaid “bump and dent” structure of the present invention holds by clamping the periphery of the proton exchange membrane of the MEA and accomplishes high-quality sealing without using adhesive and O-rings additionally. Hence, the present invention solves the drawbacks of conventional packages for fuel cells, namely time-consuming, laborious, high sealing costs, and relatively great weight of a fuel cell stack.

The embodiments and effects of the present invention will be illustrated below with reference to the accompanying drawings.

### BRIEF DESCRIPTION OF THE DRAWINGS

FIG. 1A is a schematic view of a first polar plate according to a first embodiment of the present invention.

FIG. 1B is a schematic view of a second polar plate according to the first embodiment of the present invention.

FIG. 1C is a schematic view of assembly according to the first embodiment of the present invention.

FIG. 2A is a schematic view of a first polar plate in a second embodiment of the present invention.

FIG. 2B is a schematic view of a second polar plate according to the second embodiment of the present invention.

FIG. 2C is a schematic view of assembly according to the second embodiment of the present invention.

FIG. 3A is a schematic view of a first polar plate according to a third embodiment of the present invention.

FIG. 3B is a schematic view of a second polar plate according to the third embodiment of the present invention.

FIG. 3C is a schematic view of assembly according to the third embodiment of the present invention.

### DETAILED DESCRIPTION

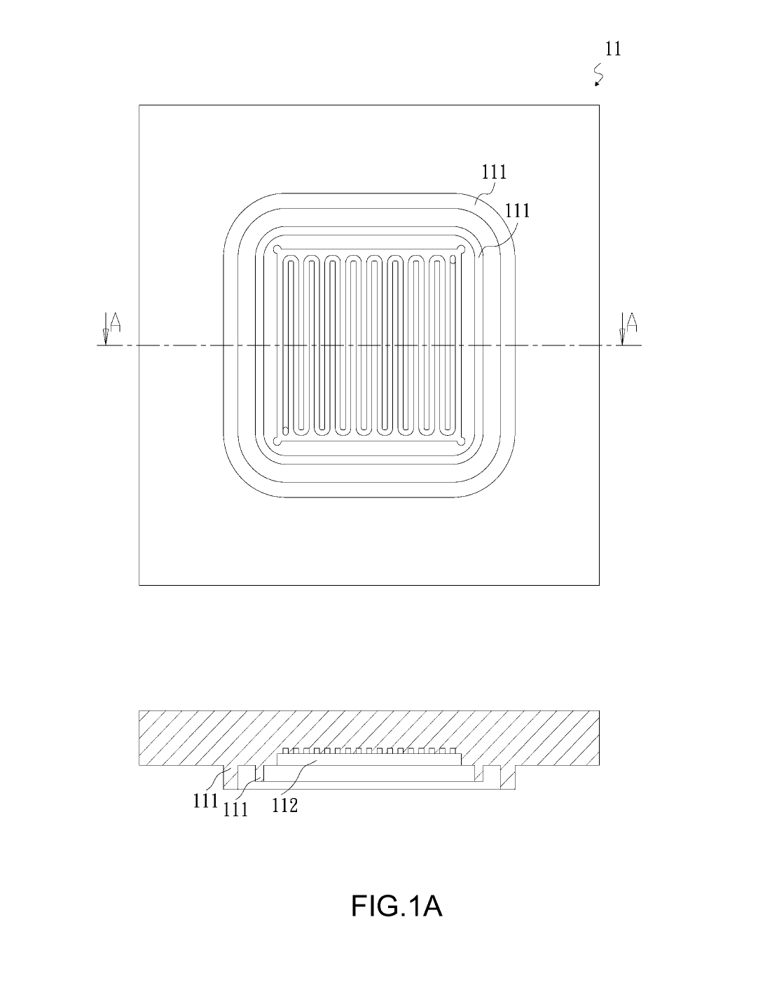

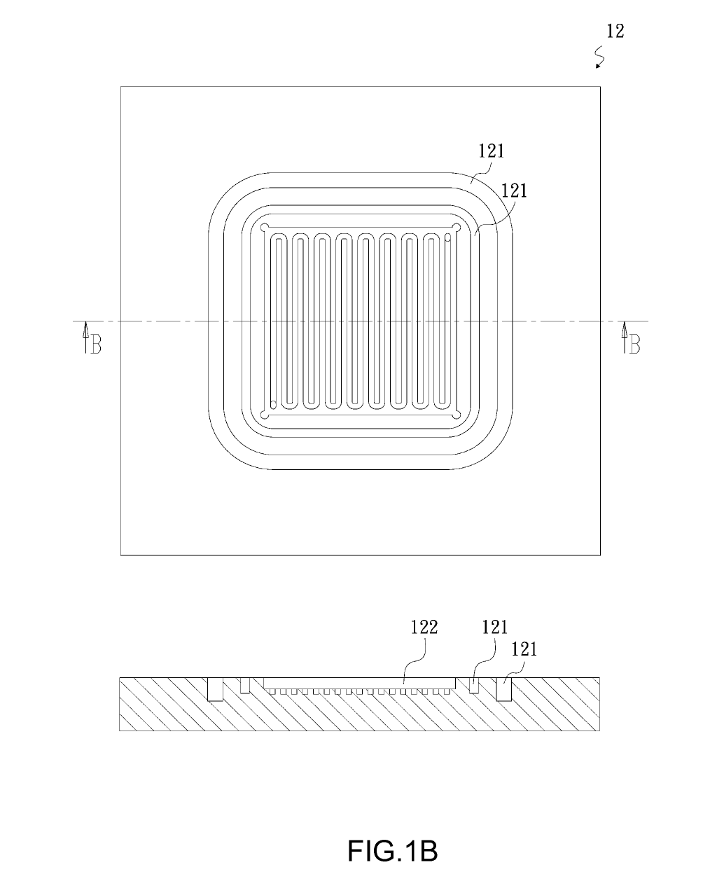

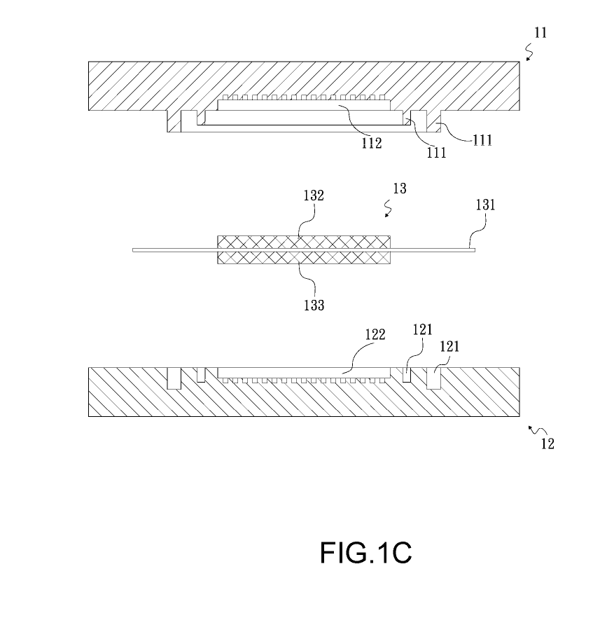

Please refer to FIGS. 1A-1C. FIGS. 1A-1C are schematic views of a first polar plate, a second polar plate, and assembly in a first embodiment, respectively, wherein:

A first polar plate 11 includes a first recess 112 used to accommodate an anode 132 of a membrane electrode assembly (MEA) 13; and a first sealed flange 111 surrounding the first recess 112. Despite the two said first sealed flanges 111 in the embodiment, the number of said first sealed flanges 111 is selectively one or at least two as needed.

A second polar plate 12 includes a second recess 122 corresponding in position to the first recess 112 and used to accommodate a cathode 133 of the MEA 13; and at least a first sealed groove 121 surrounding the second recess 122 and corresponding in position to the first sealed flange 111. The first sealed flange 111 and the first sealed groove 121 are used to hold by clamping a periphery 131 of a proton exchange membrane of the MEA 13.

In addition to a square shown in FIG. 1A, the shape of the cross-section of the first sealed flange 111 in the first embodiment is selectively a semicircle, a V-shape, a W-shape, etc. An essential technical feature of the present invention is: the aforesaid “bump and dent” structure of whatever shape holds by clamping the periphery 131 of the proton exchange membrane of the MEA 13 and accomplishes sealing at the same time.

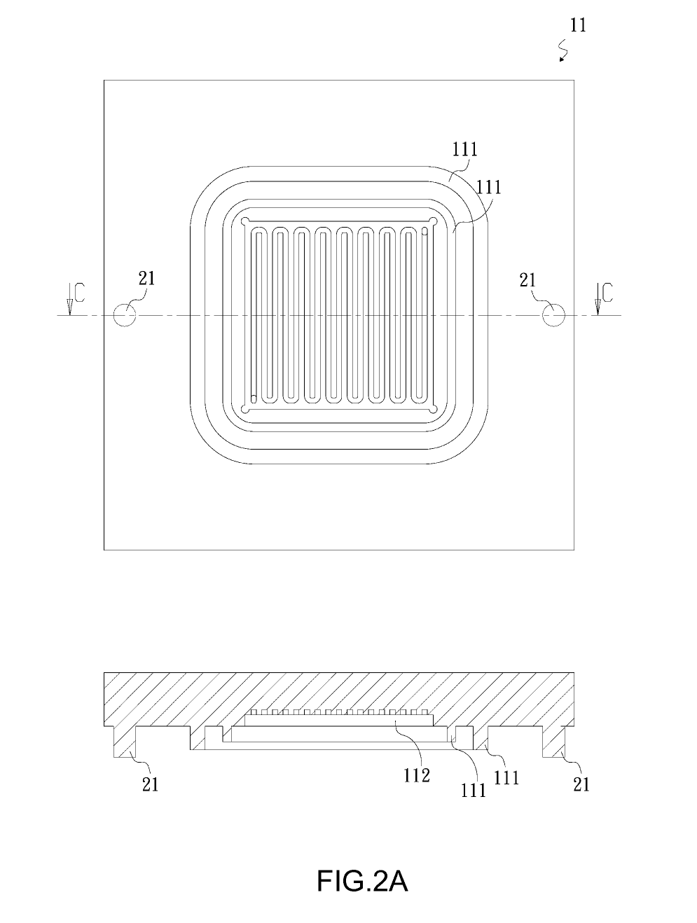

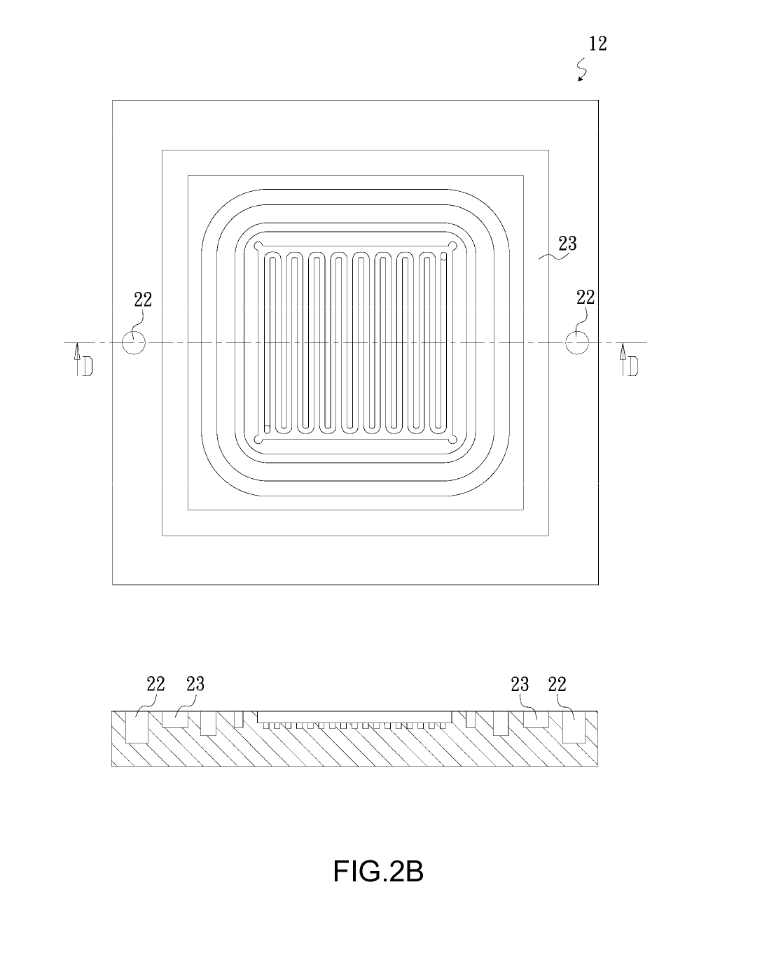

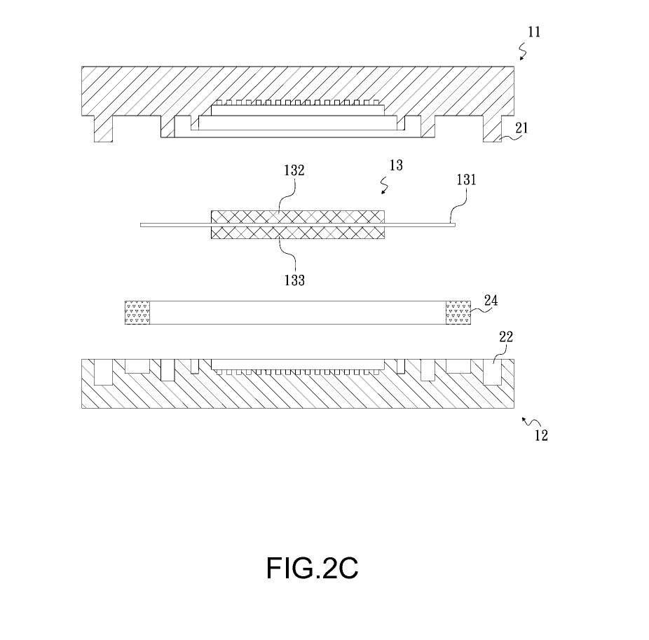

Refer to FIGS. 2A-2C now. FIGS. 2A-2C are schematic views of a first polar plate, a second polar plate, and assembly in a second embodiment, respectively. Unlike the first embodiment, the second embodiment has an O-ring groove 23, an O-ring 24, at least a bolt 21, and at least a positioning hole 22.

The O-ring groove 23 surrounds the first sealed groove 121 and the second recess 122 and is used to accommodate the O-ring 24. Depth of the O-ring groove 23 is slightly less than thickness of the O-ring 24.

The bolt 21 and the positioning hole 22 together prevent assembly workers from damaging the MEA 13 by assembling wrongly the first polar plate 11, the second polar plate 12, and the MEA 13.

In addition, an adhesive (not shown) is selectively applied to the first sealed flange 111 and the first sealed groove 121 so as to further enhance sealing. The adhesive is selected from the group including silicon resin, epoxy resin, acrylic resin, or a combination thereof.

In accordance with the description above, the adhesive may also employ two-component resin including polyester and polyurethane.

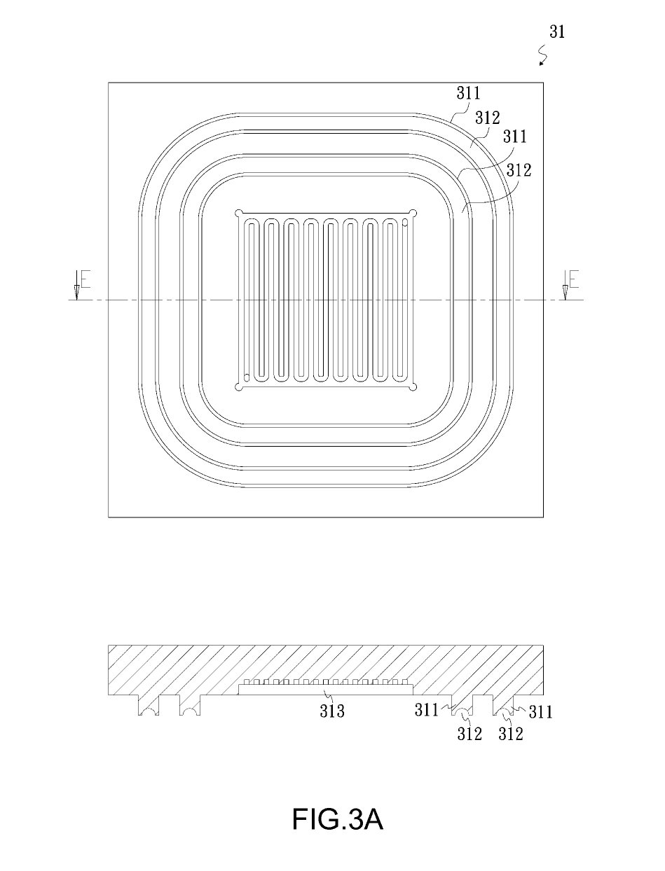

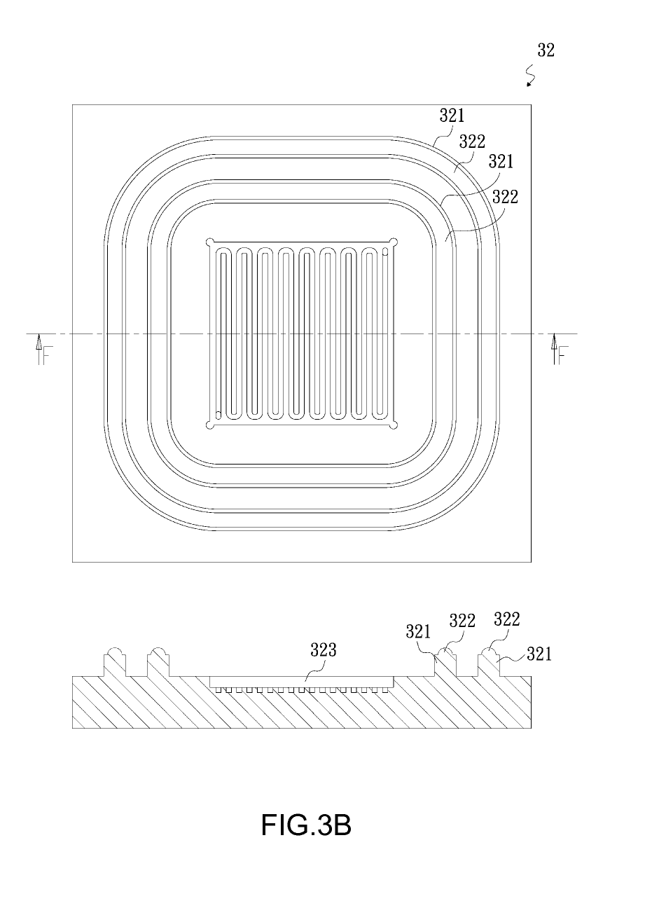

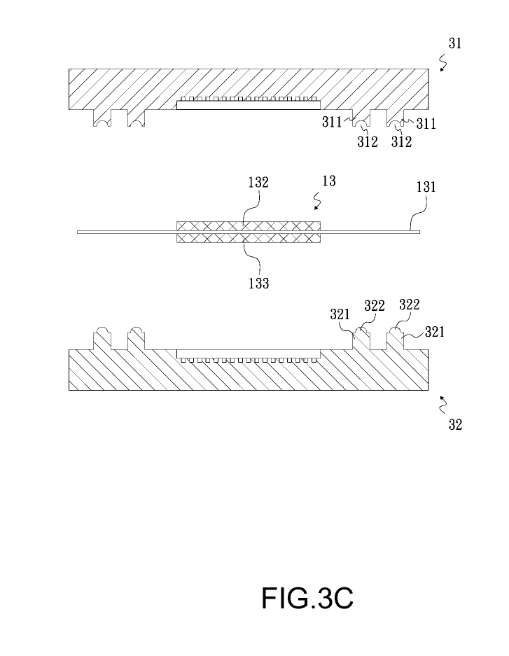

Refer to FIGS. 3A-3C now. FIGS. 3A-3C are schematic views of a first polar plate, a second polar plate, and assembly in a third embodiment, respectively, wherein:

A first polar plate 31 includes a first recess 313 used to accommodate an anode 132 of the MEA 13, and at least a second sealed flange 311 surrounding the first recess 313 and having a top surface with a second sealed groove 312.

A second polar plate 32 includes a second recess 323 corresponding in position to the first recess 313 and used to accommodate a cathode 133 of the MEA 13, and at least a third sealed flange 321 surrounding the second recess 323 and having a top surface with a fourth sealed flange 322. The second sealed groove 312 and the fourth sealed flange 322 are used to hold by clamping the periphery 131 of the proton exchange membrane of the MEA 13 and accomplish sealing.

In the embodiment, the second sealed groove 312 is provided on the top surface of the second sealed flange 311, and the fourth sealed flange 322 is provided on the top surface of the third sealed flange 321, thereby employing the second sealed groove 312 and the fourth sealed flange 322 to hold by clamping the periphery 131 of the proton exchange membrane of the MEA 13 and accomplish sealing at the same time.

Although the technology content of the present invention has been disclosed above with preferred embodiments, it is not intended to restrict the scope of the present invention. That a number of modifications and variations made by those skilled in the art without departing from the spirit of the present invention, should fall within the scope of the present invention. Therefore, the scope of protection of the present invention is determined by the appended claims.

What is claimed is:

1. A package structure for a fuel cell, comprising:
a first polar plate, comprising:
a first recess used to accommodate an anode of a membrane electrode assembly (MEA); and
at least a first sealed flange surrounding the first recess; and
a second polar plate provided beneath the first polar plate, comprising:
a second recess corresponding in position to the first recess and used to accommodate a cathode of the MEA; and
at least a first sealed groove surrounding the second recess and corresponding in position to the first sealed flange, wherein the first sealed flange and the first sealed groove are used to hold by clamping a periphery of a proton exchange membrane of the MEA.

2. The package structure for a fuel cell of claim 1, wherein the first sealed flange has a cross-section of a shape selected from the group consisting of a semicircle, a square, a V-shape, a W-shape, and a combination thereof.

3. The package structure for a fuel cell of claim 1, wherein the first polar plate further comprises:
at least a bolt.

4. The package structure for a fuel cell of claim 3, wherein the second polar plate further comprises:
at least a positioning hole corresponding in position to the bolt.

5. The package structure for a fuel cell of claim 1, further comprising:
an adhesive for gluing the periphery of the proton exchange membrane of the MEA, the first sealed groove, and the first sealed flange together.

6. The package structure for a fuel cell of claim 5, wherein the adhesive is selected from the group consisting of silicon resin, epoxy resin, acrylic resin, and a combination thereof.

7. The package structure for a fuel cell of claim 5, wherein the adhesive is a two-component resin.

8. The package structure for a fuel cell of claim 7, wherein the two-component resin comprises polyester and polyurethane.

9. The package structure for a fuel cell of claim 1, wherein the second polar plate further comprises:
an O-ring groove surrounding the first sealed groove and the second recess and used to accommodate an O-ring, wherein depth of the O-ring groove is slightly less than thickness of the O-ring.

10. The package structure for a fuel cell of claim 9, further comprising:
an adhesive for gluing the O-ring, the O-ring groove, and the first polar plate together.

11. The package structure for a fuel cell of claim 10, wherein the adhesive is selected from the group consisting of silicon resin, epoxy resin, acrylic resin, and a combination thereof.

12. The package structure for a fuel cell of claim 10, wherein the adhesive is a two-component resin.

13. The package structure for a fuel cell of claim 12, wherein the two-component resin comprises polyester and polyurethane.

14. A package structure for a fuel cell, comprising:
a first polar plate, comprising:
a first recess used to accommodate an anode of a membrane electrode assembly (MEA); and
at least a second sealed flange surrounding the first recess and having a top surface with a second sealed groove; and
a second polar plate provided beneath the first polar plate, comprising:
a second recess corresponding in position to the first recess and used to accommodate a cathode of the MEA; and
at least a third sealed flange surrounding the second recess and having a top surface with a fourth sealed flange, wherein the second sealed groove and the fourth sealed flange are employed to hold by clamping a periphery of a proton exchange membrane of the MEA.

15. The package structure for a fuel cell of claim 14, wherein the fourth sealed flange has a cross-section of a shape selected from the group consisting of a semicircle, a square, a V-shape, a W-shape, and a combination thereof.

16. The package structure for a fuel cell of claim 14, wherein the first polar plate further comprises:
at least a bolt.

17. The package structure for a fuel cell of claim 16, wherein the second polar plate further comprises:
at least a positioning hole corresponding in position to the bolt.

18. The package structure for a fuel cell of claim 14, further comprising:
an adhesive for gluing the periphery of the proton exchange membrane of the MEA, the second sealed groove, and the fourth sealed flange together.

19. The package structure for a fuel cell of claim 14, wherein the second polar plate further comprises:
an O-ring groove surrounding the third sealed flange and the second recess and used to accommodate an O-ring, wherein depth of the O-ring groove is slightly less than thickness of the O-ring.

20. The package structure for a fuel cell of claim 19, further comprising:
an adhesive for gluing the O-ring, the O-ring groove, and the first polar plate together.
